(19) United States
(12) Patent Application Publication
(10) Pub. No.: US 2026/0089065 A1
(43) Pub. Date: Mar. 26, 2026

(54) IDENTIFYING SLOW NODES IN DISTRIBUTED APPLICATIONS

(71) Applicant: Hewlett Packard Enterprise Development LP, Spring, TX (US)

(72) Inventors: Gregg Bernard Lesartre, Fort Collins, CO (US); Aaron J. Hoelscher, Eleva, WI (US); Duncan Roweth, Bristol (GB)

(21) Appl. No.: 18/897,686

(22) Filed: Sep. 26, 2024

(51) Int. Cl. H04L 41/142; H04L 41/082; H04L 41/16; H04L 43/04; H04L 67/10

(52) U.S. Cl. CPC H04L 41/142; H04L 41/082; H04L 41/16; H04L 43/04; H04L 67/10

(57) ABSTRACT

One aspect of the instant disclosure provides a method and system for identifying slow nodes among a plurality of nodes executing a distributed application. During operation, in response to receiving a trigger signal at a node, the system may monitor traffic to or from the node by measuring durations of one or more non-paused idle periods. In response to determining that a duration of a non-paused idle period falls within a predetermined idle-period duration range, the system may increment a corresponding counter. The system may generate a histogram for the node based on counter values corresponding to a plurality of idle-period duration ranges and identify one or more slow nodes based on histograms associated with the plurality of nodes.

### STATEMENT OF GOVERNMENT-FUNDED RESEARCH

This invention was made with Government support under Contract Number H98230-23-C-0350 awarded by the Maryland Procurement Office. The Government has certain rights in this invention.

### BACKGROUND

### Field

This disclosure is generally related to the execution of distributed applications (e.g., high-performance computing applications or machine-learning applications). More specifically, this disclosure is related to identifying slow nodes within a cluster of nodes in a distributed computing environment.

### Related Art

Distributed applications such as high-performance computing (HPC) applications typically rely on a large number of nodes working together to solve complex problems. The performance of an application is often limited by the slow nodes.

Identifying slow nodes in the execution of an application can be important for debugging purposes.

### BRIEF DESCRIPTION OF THE FIGURES

FIG. 1 illustrates an example high-performance computing (HPC) environment, according to one aspect of the instant disclosure.

FIG. 2 illustrates an example structure of the idle histogram, according to one aspect of the instant disclosure.

FIG. 3 illustrates the example block diagram of an idle-histogram circuit, according to one aspect of the instant disclosure.

FIG. 4 illustrates an example network interface controller (NIC), according to one aspect of the instant disclosure.

FIG. 5 illustrates the field map of an example Control and Status Register (CSR), according to one aspect of the instant disclosure.

FIG. 6 presents a flowchart illustrating an example process for identifying slow nodes, according to one aspect of the instant disclosure.

FIG. 7 illustrates examples of histograms of a well-behaved node and a slow node, according to one aspect of the instant disclosure.

FIG. 8 illustrates a computer system for facilitating the identification of slow nodes, according to one aspect of the instant disclosure.

FIG. 9 illustrates a computer-readable medium that facilitates the identification of slow nodes, according to one aspect of the instant disclosure.

In the figures, like reference numerals refer to the same figure elements.

### DETAILED DESCRIPTION

High-performance computing (HPC) applications may be running on a large number of nodes (e.g., computing devices), and application data is often exchanged among those nodes during the execution of the applications. For example, various computing nodes participating in a complex computing task may need to exchange their intermediate computation results. Because different nodes may operate under different conditions (e.g., they may have different computing powers or loads, or they may be subjected to faults or power control), some nodes may run slower than others. In situations where the application is globally synchronized, before the application advances to the next execution stage, all nodes may need to wait for the slowest node or nodes to finish their computations of the current execution stage. In situations where a process executing on one node has local connectivity with a set of neighboring nodes, the node may need to wait for its slower neighbors to finish their computation in order to advance to the next stage. In other words, the performance of the application is limited by the performance of the slower nodes. Improving the application performance often requires identifying and repairing or removing (when necessary) the slow nodes, which can be a challenge for a system with many interconnected nodes.

Conventional approaches for monitoring application performance may include measuring the average idle time of each node to identify slow nodes. Such approaches often do not distinguish the culprit nodes from the victim nodes because some idling nodes may be waiting for other nodes and are not faulty. Some approaches may collect a trace of the activities of each node to detect slow nodes. However, a sufficiently long trace is usually needed, which is stored in a large amount of storage space, especially for a large system. Software-based approaches are often time-consuming and do not provide sufficiently fine granularity. To efficiently and accurately identify slow nodes among a large number of nodes, some aspects of the instant disclosure provide a hardware-based solution that creates histograms of non-paused idle durations for each node to facilitate the identification of slow nodes. Note that a node may appear to be idle when paused (due to congestion control) from sending and receiving traffic. A non-paused idle duration refers to time the node spends waiting for other nodes to finish their computations before advancing to the next stage. The hardware-based solution may be implemented on the network interface controller (NIC) of each node and may be used to create the histograms for both the inbound and outbound directions.

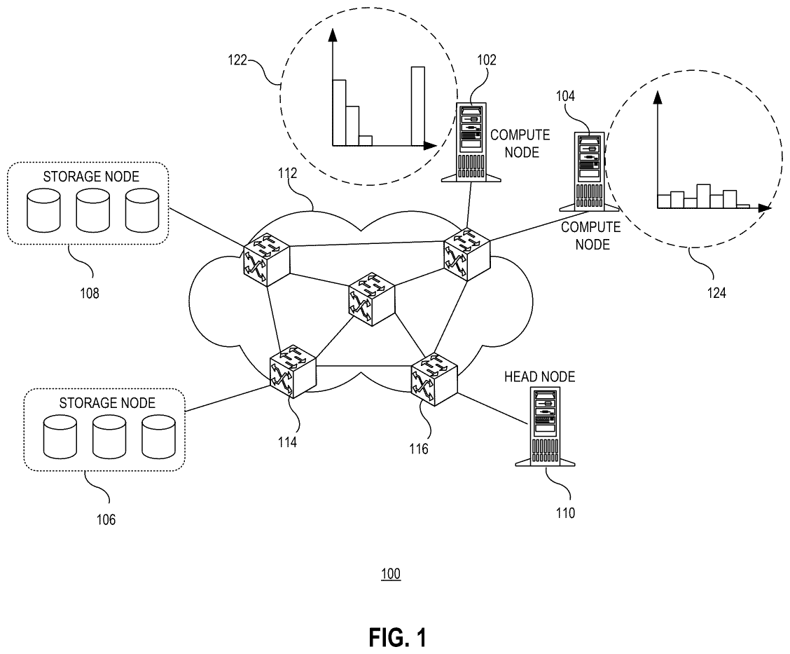

FIG. 1 illustrates an example high-performance computing (HPC) environment, according to one aspect of the instant disclosure. In FIG. 1, an HPC environment 100 may include a plurality of nodes, including compute nodes (e.g., nodes 102 and 104), storage nodes (e.g., nodes 106 and 108), and a head node 110, coupled to each other via a switch fabric 112 comprising a plurality of switches (e.g., switches 114 and 116).

An HPC environment may include any number of nodes, which may be homogeneous or heterogeneous in regards to device capabilities, and that provides a platform for executing HPC applications (e.g., Artificial Intelligence (AI), machine learning, deep learning, autonomous driving, product design and manufacturing, weather modeling and forecasting, seismic data analysis, financial risk assessment, fraud detection, computational fluid dynamics, DNA sequencing, contextual search algorithms, traffic management, complex simulations, drug research, virtual reality, augmented reality, etc.). HPC environments often provide a platform for executing application workloads that use large numbers of nodes to perform various portions of the application, and, as such, often transmit data to one another over a network (discussed further below).

Each node in FIG. 1 is a computing device, which may be any single computing device, a set of computing devices, a portion of one or more computing devices, or any other physical, virtual, and/or logical grouping of computing resources. According to some aspects, a computing device is any device, portion of a device, or any set of devices capable of electronically processing instructions and may include, but is not limited to, any of the following: one or more processors (e.g., components that include circuitry) (not shown), memory (e.g., random access memory (RAM)) (not shown), input and output device(s) (not shown), non-volatile storage hardware (e.g., solid-state drives (SSDs), persistent memory (Pmem) devices, hard disk drives (HDDs) (not shown)), one or more physical interfaces (e.g., network ports, storage ports) (not shown), any number of other hardware components (not shown), and/or any combination thereof.

Examples of computing devices include, but are not limited to, a server (e.g., a blade-server in a blade-server chassis, a rack server in a rack, etc.), a desktop computer, a mobile device (e.g., laptop computer, smartphone, personal digital assistant, tablet computer, automobile computing system, and/or any other mobile computing device), a storage device (e.g., a disk drive array, a fiber channel storage device, an Internet Small Computer Systems Interface (ISCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, and/or any other type of computing device with the aforementioned requirements.

In this example, head node 110 may be a physical server that controls all nodes involved in the execution of the HPC application and is used for management, job control, and launching jobs across the compute nodes. Each compute node may be a physical server coupled to head node 110 and is used to provide computational processing capacity for the HPC workloads. Although FIG. 1 shows two compute nodes, in practice, an HPC cluster may include hundreds or thousands of compute nodes that are networked together (e.g., via switch fabric 112).

While executing an HPC application, due to various factors (e.g., being overloaded or experiencing failure), some nodes may execute their tasks much slower than other nodes, which can slow down the entire application because other nodes have to wait (i.e., remain idle) for the execution results from the slow nodes to advance to the next stage. To identify the slow node or nodes, according to some aspects, a histogram of idle but non-paused durations may be created for each compute node.

The more time a node spends waiting for other nodes, the less likely the node is a slow node. In the example shown in FIG. 1, a histogram 122 is created for compute node 102, and a histogram 124 is created for compute node 104. A node is said to be idle but not paused when it does not send or receive packets and is not paused by congestion-control measures. Histograms from the plurality of compute nodes may be sent to head node 102, which may then identify one or more slow nodes among the plurality of nodes based on the histograms. For example, a histogram with many long idle but non-paused cycles may indicate that the corresponding node often waits for other nodes and, therefore, is not the laggard.

Each node in HPC environment 100 may send and receive packets via a network interface controller (NIC). A NIC typically may include a host interface (HI) (e.g., an interface for connecting to the host processor) and a high-speed network interface (HNI) for communicating with the switch fabric 112. According to some aspects, the HNI of the NIC may include a logic unit (referred to as idle-histogram logic unit) responsible for creating the histograms about the non-paused idle cycles. The idle-histogram logic unit may collect statistics about the non-paused idle periods by monitoring packets flowing in and out of the HNI and creating a histogram that reflects the distribution of the duration of the non-paused idle periods.

According to some aspects, the idle-histogram logic unit may monitor traffic on the HNI for a predetermined sample period (e.g., 7) to collect statistics about the non-paused idle periods during the predetermined sample period. According to further aspects, the duration of the sample period may be divided into a predetermined number (e.g., eight) of configurable bins, and the non-paused idle periods of the HNI (either in the inbound or outbound direction) within the sample periods may be sorted based on their durations (which may be measured in numbers of consecutive clock periods). For example, a non-paused idle period with a duration of 100 clock cycles may fall into one bin, whereas a non-paused idle period with a duration of 200 clock cycles may fall into a different bin.

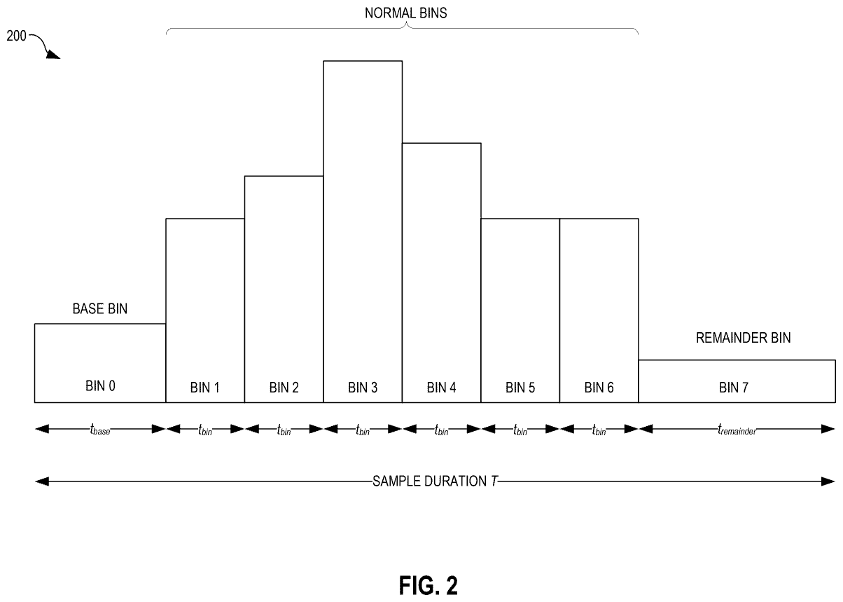

FIG. 2 illustrates an example structure of the idle histogram, according to one aspect of the instant disclosure. In FIG. 2, histogram 200 includes eight bins (i.e., bin 0 to bin 7) occupying a sample period, where bin 0 is referred to as a base bin, bins 1 to bin 6 are referred to as normal bins, and bin 7 is referred to as a remainder bin. The sample period is denoted T, the width of the base bin is denoted t_{base}, the width of the normal bins is denoted thin, and the width of the remainder bin is denoted t_{remainder}.

The base bin (i.e., bin 0) contains non-paused idle periods with the lowest durations. More specifically, the count of the base bin may increment each time a non-paused idle period with a duration between zero and t_{base} is detected. The six normal bins (e.g., bin 1 to bin 6) have the same width, and each contain non-paused idle periods with incrementing durations. For example, bin 1 contains non-paused idle periods with a duration between t_{base} and t_{base}+t_{bin}, bin 2 contains non-paused idle periods with a duration between t_{base}+t_{bin} and t_{base}+2t_{bin}, and so on. In general, a normal bin i may contain non-paused idle periods with a duration between t_{base}+(i−1). t_{bin} and t_{base}+i·t_{bin}. The reminder bin (i.e., bin 7) contains non-paused idle periods with the longest durations (e.g., with a duration up to 7). In the example shown in FIG. 2, the width of remainder bin is T−t_{base}−6t_{bin}.

Because different HPC applications may have different traffic patterns (e.g., some may require more frequent data exchange among participating nodes), the sample period and the width of each bin may be configurable to ensure that the histograms can accurately reflect the traffic patterns on those nodes. For example, shorter sample periods and narrower bin width may be used if the nodes are exchanging data more frequently. In the example shown in FIG. 2, there are eight bins. In practice, depending on the hardware design of the NIC (e.g., the number of available counters), the number of bins may be more or less than eight.

According to some aspects, each bin of histogram 200 may correspond to a counter, and histogram 200 may be represented using a set of counter values (e.g., eight counter values). A counter may increment in response to detecting a non-paused idle period falls into its corresponding bin (i.e., its duration of the non-paused idle period is within the range of the corresponding bin).

According to some aspects, the various time parameters of the histogram, including the sample period and the bin widths, may be defined using the number of clock periods. For example, the sample period T may be defined using a number N_{T}, representing the number of clock periods within T.

According to some aspects, the idle histogram may be created for either the ingress or egress traffic, or both. In some examples, the ingress and egress histograms may be generated sequentially using the same hardware components (e.g., the same set of counters). In alternative examples, the ingress and egress histograms may be generated in parallel using different hardware components (e.g., different sets of counters).

According to some aspects, the idle histogram may be generated periodically. For example, host software may periodically send an enable signal to the idle-histogram logic unit on the NIC to trigger the generation of the histograms.

According to alternative aspects, the idle histogram may be generated on demand as part of the system debugging process.

According to some aspects, the idle histogram may be created for all traffic to or from the node, regardless of the traffic class, meaning that the idle-histogram logic unit may monitor all traffic classes to detect non-paused idle periods during which no packet is received or transmitted. According to alternative aspects, the idle histogram may be created for a particular traffic class, meaning that the idle-histogram logic unit only monitors that particular traffic class to detect non-paused idle periods during which no packet of that particular traffic class is received or transmitted. In some examples, the idle-histogram logic unit may monitor traffic for multiple traffic classes and generate a histogram for each monitored traffic class.

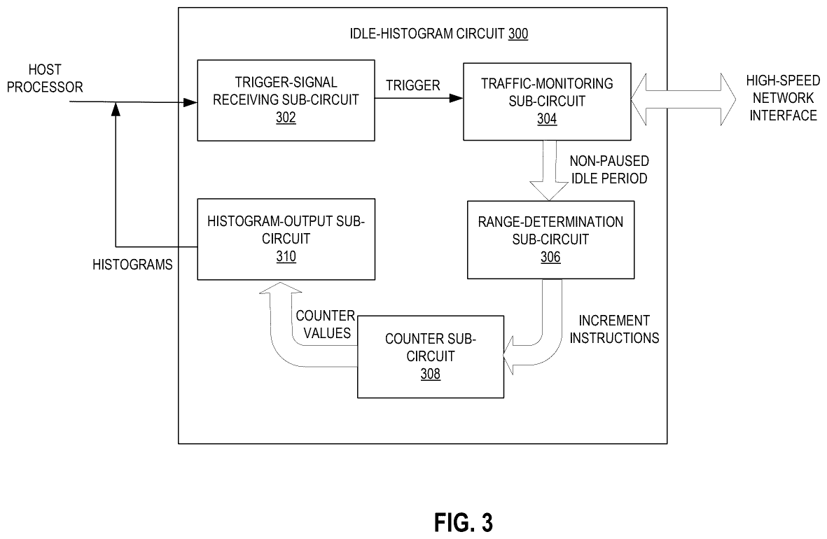

FIG. 3 illustrates the example block diagram of an idle-histogram circuit, according to one aspect of the instant disclosure. In the example shown in FIG. 3, idle-histogram circuit 300 may include a number of sub-circuits that collaborate with each other to achieve the goal of creating a histogram of non-paused idle periods of an HPC node, thus facilitating the identification of one or more slow nodes among a plurality of nodes execution an HPE application.

The circuit and subcircuits may be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits or sub-circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality.

In the example shown in FIG. 3, idle-histogram circuit 300 may be part of the NIC of a compute node and may include a trigger-signal receiving sub-circuit 302, a traffic-monitoring sub-circuit 304, a range determination sub-circuit 306, a counter sub-circuit 308, and a histogram-output sub-circuit 310.

Trigger-signal receiving sub-circuit 302 may be responsible for receiving a trigger signal from a host processor (e.g., the processor of the compute node).

According to some aspects, software executing on the host processor may write to a Control and Status Register (CSR) to set the value of the CSR to one, which may serve as the trigger signal. According to some aspects, trigger-signal receiving sub-circuit 302 may receive the trigger signal periodically or on demand.

Traffic-monitoring sub-circuit 304 may be responsible for monitoring traffic on the NIC in response to trigger-signal receiving sub-circuit 302 receiving the trigger signal. According to some aspects, traffic-monitoring sub-circuit 304 may be configured to monitor the traffic for a predetermined duration (i.e., the sample period). Traffic-monitoring sub-circuit 304 may be configured to monitor the traffic in a predetermined direction (i.e., the inbound or outbound direction, or both). According to further aspects, traffic-monitoring sub-circuit 304 may be configured to monitor the traffic for all traffic classes or a subset of traffic classes. While monitoring the traffic, traffic-monitoring sub-circuit 304 may identify non-paused idle periods, which are intervals during which no packets of the monitored traffic class(es) are transmitted or received.

Range-determination sub-circuit 306 may be responsible for determining the range of the durations of the non-paused idle periods detected by traffic-monitoring sub-circuit 304. According to some aspects, for each non-paused idle period, range-determination sub-circuit 306 may be configured to identify, among a plurality of predetermined ranges (e.g., the bins shown in FIG. 2), one range to which the duration of the non-paused idle period belongs. For example, range-determination sub-circuit 306 may compare the duration of the non-paused idle period with the lower and upper bounds of each bin.

Counter sub-circuit 308 may include a plurality of counters, each counter corresponding to a duration range of the non-paused idle periods. According to some aspects, once range-determination sub-circuit 306 determines that a non-paused idle period detected by traffic-monitoring sub-circuit 304 belongs to a particular duration range or bin, it may send an increment instruction to a corresponding counter to increment its value by one. In one example, counter sub-circuit 308 may include eight counters to facilitate the generation of a histogram with eight bins (e.g., histogram 200 shown in FIG. 2). The histogram may be generated for the inbound or outbound traffic. To facilitate the parallel generation of histograms for both the inbound and outbound, counter sub-circuit 308 may include two sets of counters, one per histogram.

Histogram-output sub-circuit 310 may be responsible for outputting the histograms. According to some aspects, a histogram may be represented using the counter values of the plurality of counters in counter sub-circuit 308 and may be sent to the host processor. According to further aspects, histograms from a plurality of compute nodes may be sent to the head node (e.g., node 110 shown in FIG. 1), which may then identify one or more slow nodes among the plurality of compute nodes.

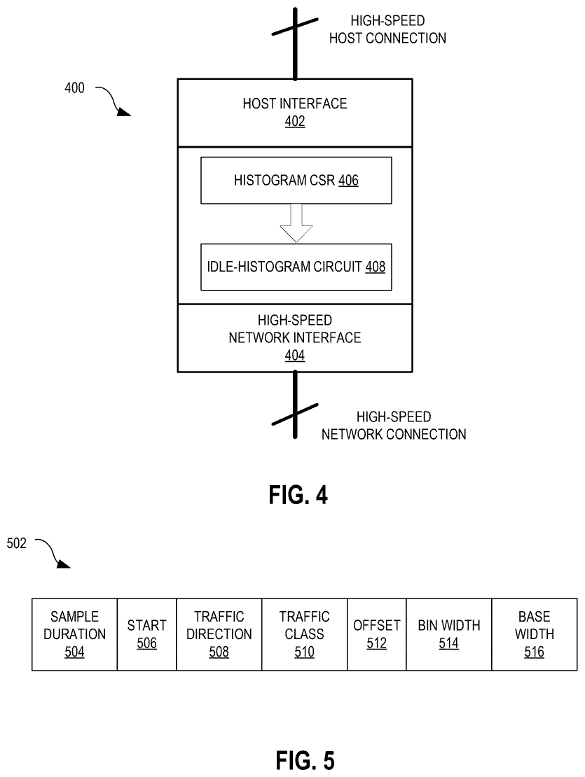

FIG. 4 illustrates an example network interface controller (NIC), according to one aspect of the instant disclosure. In FIG. 4, a NIC 400 includes a host interface (HI) 402, a high-speed network interface (HNI) 404, a histogram CSR 406, and an idle-histogram circuit 408. NIC 400 may be part of a compute node to provide network connectivity to the compute node. A compute node may include one or more NICs. In some examples, a compute node may include one, two, four, or eight NICs.

HI 402 may include a peripheral component interconnect (PCI) or a peripheral component interconnect express (PCIe) interface and may be coupled to the host via a host connection with multiple lanes (e.g., PCIe Gen 4 lanes capable of operating at signaling rates up to 25 Gbps per lane). HNI 404 may facilitate a high-speed network connection for communicating with a link in the switch fabric. HNI 404 may operate at aggregate rates of either 100 Gbps or 200 Gbps using multiple full-duplex serial lanes. HNI 404 may support the Institute of Electrical and Electronics Engineers (IEEE) 802.3 Ethernet-based protocols as well as an enhanced frame format that provides support for higher rates of small messages.

Idle-histogram circuit 408 may be responsible for generating histograms of non-paused idle periods on NIC 400 and may be similar to circuit 300 shown in FIG. 3. Histogram CSR 406 may be used to change the configurations of the various sub-circuits in idle-histogram circuit 408. Software executing on the host processor may write to histogram CSR 406, thus changing the configuration of idle-histogram circuit 408. According to some aspects, histogram CSR 406 may include a plurality of fields corresponding to a plurality of configurable parameters (e.g., sample period, bin widths, etc.) of the histogram. Each field may include one or more bits.

FIG. 5 illustrates the field map of an example Control and Status Register (CSR), according to one aspect of the instant disclosure. In FIG. 5, CSR 502 may include a sample duration field 504, a start field 506, a traffic direction field 508, a traffic class field 510, an offset field 512, a bin width field 514, and a base width field 516. Sample duration field 504 specifies the duration of the sample period (i.e., the time window for monitoring the traffic). According to some aspects, the duration of the sample period may be expressed using the number of clock periods. According to further aspects, sample duration field 502 may include 32 bits.

Start field 506 indicates the beginning of the traffic monitoring and idle periods measurement. The idle-histogram circuit may monitor the CSR fields and start to monitor traffic on the NIC to detect non-paused idle periods in response to detecting that start field 506 is set to a predetermined value. According to some aspects, start field 506 may include one bit, and the measurement starts when the bit is set to one.

Traffic direction field 508 specifies the direction of monitored traffic, which may be ingress or egress direction. According to some aspects, one value of traffic direction field 508 may configure the idle-histogram circuit to capture ingress traffic and a different value may configure the circuit to capture egress traffic. In one example, traffic direction field 508 may include one bit, which specifies the ingress direction when set to one and the egress direction when set to zero.

Traffic class field 510 specifies the to-be-monitored traffic class. According to some aspects, traffic class field 510 may include a plurality of bits, with one or more bits corresponding to each traffic class. In one example, when all bits of traffic class field 510 are set as one, all traffic classes are monitored. In another example, a subset of bits of traffic class field 510 may be set to configure the circuit to monitor a particular traffic class or multiple traffic classes. In addition to traffic class field 510, CSR 502 may also include a field specifying one or more to-be-monitored application or service and/or a field specifying one or more phase in the execution of a particular application.

Offset field 512 and bin width field 514 together specify the width of the normal bin (e.g., bin 0 to bin 6 shown in FIG. 2). According to some aspects, the duration of the normal may be expressed using the number of clock periods. According to some aspects, the values stored in offset field 512 or bin width field 514 may be the binary logarithm of the clock periods. In one example, the width of the normal bin is 64 clock periods, and bin width field 514 may have a value of 6. In some examples, offset field 512 and bin width field 514 each may have four bits.

Base width field 512 specifies the width of the base bin (e.g., bin 0 shown in FIG. 2). According to some aspects, the width of the base bin may be expressed using the number of clock periods. According to further aspects, base width field 516 may include eight bits, and the default width of the base bin may be 15 clock periods.

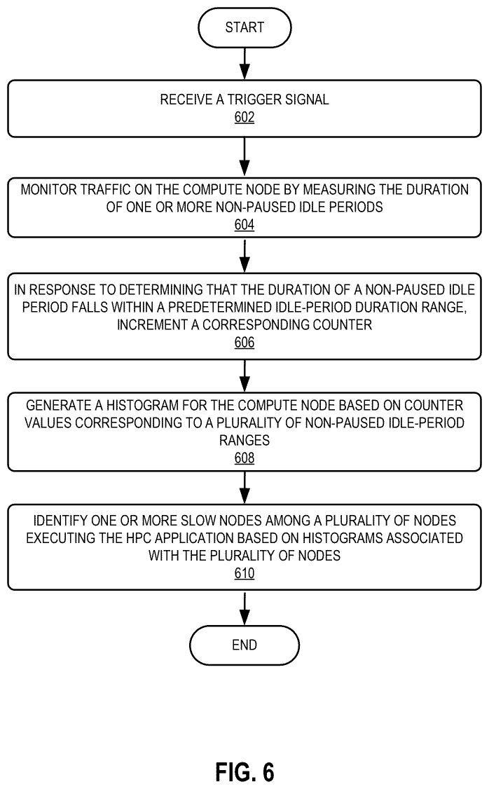

FIG. 6 presents a flowchart illustrating an example process for identifying slow nodes, according to one aspect of the instant disclosure. All or any portion of the operations shown in FIG. 6 may be performed, for example, by a device or set of devices (e.g., nodes 102-110, idle-histogram circuit 300, or NIC 400 shown in FIG. 1, FIG. 3, and FIG. 4, respectively). Although the example process in FIG. 6 shows a specific order of performing certain operations, the process is not limited to such an order. Operations shown in succession in the flowchart may be performed in a different order and may be executed concurrently or with partial concurrence or combinations thereof.

During operation, the NIC of a compute node may receive a trigger signal (operation 602). The compute node may be one of a plurality of nodes executing an HPC application (e.g., compute node 102 or 104 shown in FIG. 1). The trigger signal may be generated and sent from the host processor of the compute node. For example, the trigger signal may be in the form of the host processor writing into a CSR (e.g., histogram CSR 406 shown in FIG. 4) of the NIC. According to some aspects, the NIC may receive the trigger signal periodically or on demand. The CSR may include a plurality of fields, similar to field map 502 shown in FIG. 5.

In response to the trigger signal, the NIC may monitor traffic to or from the compute node by measuring the duration of one or more non-paused idle periods (operation 604). A non-paused idle period refers to the interval when the compute node is waiting for computation results from other compute nodes and, hence, is not sending or receiving packets. However, the NIC is not paused (due to congestion control) from sending or receiving packets. The NIC may monitor traffic within a predetermined sample window, which is configurable. Depending on the configuration, the NIC may monitor the traffic in the ingress or egress direction. The NIC may be configured to monitor the traffic for all traffic classes, a subset of traffic classes, or a particular traffic class. The NIC may be further configured to monitor traffic for a given application or service or for one or more phase in the execution of a particular application or service.

The sample window may be divided into a set of predetermined idle-period duration ranges. In response to determining that the duration of a non-paused idle period falls within a predetermined idle-period duration range, the NIC may increment a corresponding counter (operation 606). By determining the duration ranges of all non-paused idle periods within the sample period and incrementing the counters correspondingly, the NIC may obtain the duration distribution of the non-paused idle periods in the sample period. According to some aspects, determining the duration range of a non-paused idle period may comprise comparing the duration of the non-paused idle period with lower and upper bounds of the set of predetermined idle-period duration ranges.

The NIC may generate a histogram for the compute node based on counter values corresponding to a plurality of non-paused idle-period ranges (operation 608). The x-axis of the histogram may be the idle-period duration ranges, and the y-axis may be the counter values. According to some aspects, idle-period duration ranges may include a base range, a set of normal ranges, and a remainder range. Each range may be configurable to allow a user to tune the shape of the histogram, thus ensuring that the histogram may accurately and sufficiently capture the characteristics of the duration distribution of the non-paused idle periods. The NIC may be configured to generate multiple histograms for the compute node. For example, a histogram may be generated for each of the ingress and egress traffic directions. In some examples, multiple histograms may be generated for multiple traffic classes, or one histogram may be generated for all traffic classes. In some examples, histograms for a particular node may be generated periodically or on-demand. According to some aspects, to study the behavior of the compute node over a longer time window (which may span multiple sample windows), a histogram trace comprising a plurality of histograms may be generated.

The system may identify one or more slow nodes among a plurality of nodes executing the HPC application based on histograms associated with the plurality of nodes (operation 610). The histograms generated by the plurality of compute nodes may be sent to a node (e.g., compute node 102 or 104, or head node 110 shown in FIG. 1), which may compare the histograms to identify slow nodes. According to some aspects, a machine learning technique (e.g., clustering analysis or a deep-learning neural network) may be used to distinguish histograms of slow nodes from histograms of well-behaved nodes. For a system with a large number of nodes, the clustering analysis may be performed for a large number of histograms. Histograms of well-behaved nodes may have similar patterns, whereas histograms of slow nodes may be the outliers. In another example, applying the machine learning technique may involve sampling the histograms many times for many nodes and many applications to accumulate a data set that describes many different behaviors. Once the slow nodes are identified, the system may take corresponding remedy actions (e.g., reducing the workload sent to the slow nodes or replacing the slow nodes using backup nodes).

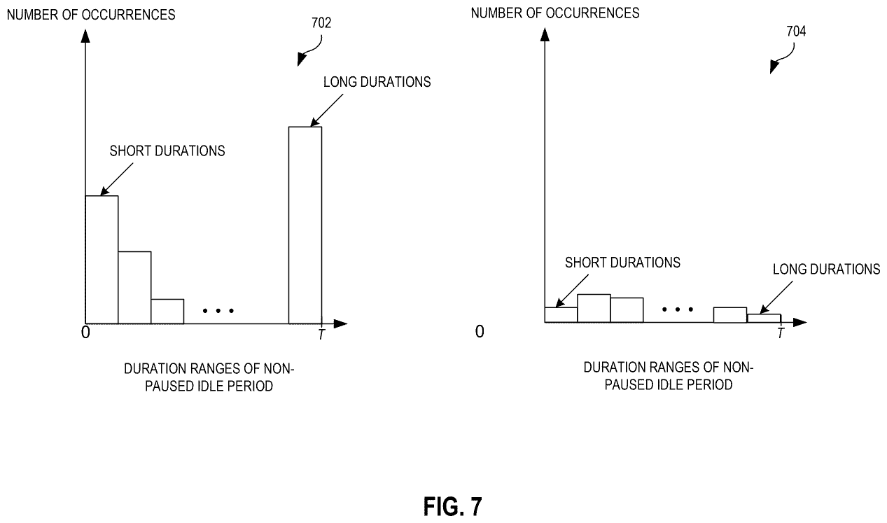

FIG. 7 illustrates examples of histograms of a well-behaved node and a slow node, according to one aspect of the instant disclosure. More specifically, FIG. 7 shows a histogram 702 for a well-behaved node and a histogram 704 for a slow node.

As can be seen from FIG. 7, histogram 702 includes a large number of non-paused idle periods with long durations, which indicates that the corresponding node spends lots of time waiting for other nodes. This corresponds to the behavior of well-behaved nodes. On the other hand, histogram 704 has fewer long non-paused idle periods, which indicates that the corresponding node rarely waits for other nodes. This corresponds to the behavior of slow nodes because other nodes typically have completed their computations before the slow nodes. When applying the machine learning technique, one may tune the various histogram parameters (e.g., bin widths and sample period) to create histograms that may be best for distinguishing the slow nodes from the well-behaved nodes.

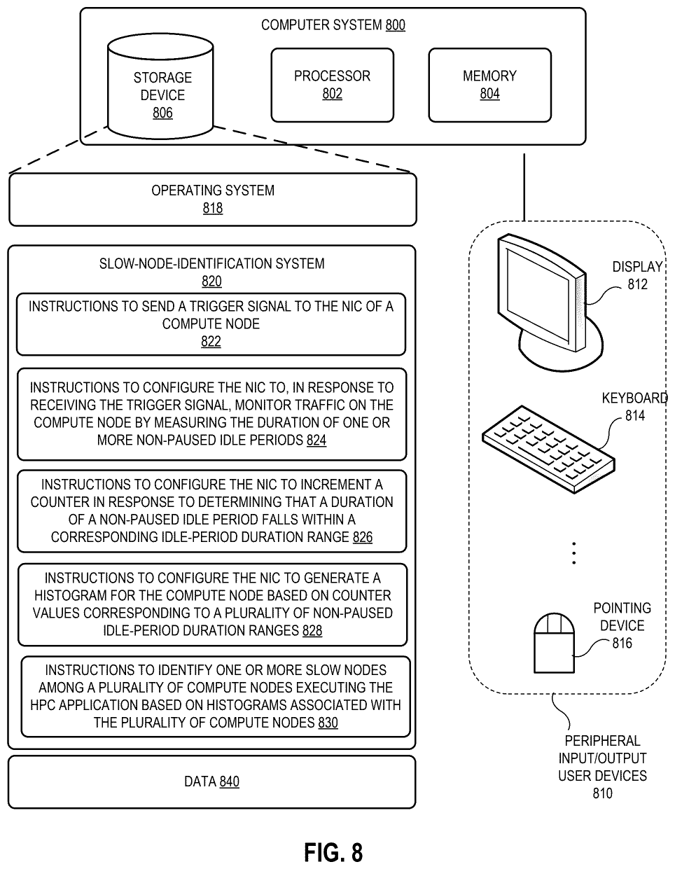

FIG. 8 illustrates a computer system for facilitating the identification of slow nodes, according to one aspect of the instant disclosure. Computer system 800 includes a processor 802, a memory 804, and a storage device 806. Furthermore, computer system 800 may be coupled to peripheral I/O user devices 810 (e.g., a display device 812, a keyboard 814, and a pointing device 816). Storage device 806 includes a non-transitory computer-readable storage medium and stores an operating system 818, a slow-node identification system 820, and data 840. According to some aspects, computer system 800 may be implemented on a node among a plurality of nodes executing an HPC application, such as compute node 102 or 104, or head node 110 shown in FIG. 1. Computer system 800 may include fewer or more entities or instructions than those shown in FIG. 8.

Slow-node identification system 820 may include instructions, which when executed by computer system 800, may cause computer system 800 to perform methods and/or processes described in this disclosure. Slow-node identification system 820 may include instructions 822 to send a trigger signal to the NIC of a compute node, as described above in relation to operation 602 shown in FIG. 6. A compute node may include one or more NICs. Sending the trigger signal may comprise writing into a CSR (e.g., histogram CSR 406 shown in FIG. 4) of the NIC. According to some aspects, the trigger signal may be sent periodically or on demand. The CSR may include a plurality of fields, similar to field map 502 shown in FIG. 5.

Slow-node identification system 820 may include instructions 824 to configure the NIC to, in response to receiving the trigger signal, monitor traffic to or from the compute node by measuring the duration of one or more non-paused idle periods, as described above in relation to operation 604 shown in FIG. 6. According to some aspects, instructions 824 may configure the NIC to monitor traffic for a predetermined sample period. According to some aspects, instructions 824 may configure the NIC to monitor the traffic in the ingress or egress direction. According to further aspects, instructions 824 may configure the NIC to monitor the traffic for all traffic classes, a subset of traffic classes, or a particular traffic class.

Slow-node identification system 820 may include instructions 826 to configure the NIC to increment a counter in response to determining that a duration of a non-paused idle period falls within a corresponding idle-period duration range, as described above in relation to operation 606 shown in FIG. 6. Instructions 826 may configure the NIC to compare the duration of the non-paused idle period with lower and upper bounds of the set of predetermined idle-period duration ranges.

Slow-node identification system 820 may include instructions 828 to configure the NIC to generate a histogram for the compute node based on counter values corresponding to a plurality of idle-period ranges, as described above in relation to operation 608 shown in FIG. 6. According to some aspects, instructions 828 may configure the NIC to generate multiple histograms for the compute node, including but not limited to histograms for the ingress and egress traffic directions, histograms for multiple traffic classes, histograms for sample periods at different time instances, etc. The histograms may be generated periodically or on demand. Instructions 828 may further configure the NIC to generate a histogram trace comprising a plurality of histograms corresponding to a plurality of sequential sample windows.

Slow-node identification system 820 may include instructions 830 to identify one or more slow nodes among a plurality of compute nodes executing the HPC application based on histograms associated with the plurality of compute nodes, as described above in relation to operation 610 shown in FIG. 6. According to some aspects, instructions 830 may include a machine-learning base algorithm (e.g., clustering analysis) that may be used to distinguish histograms of slow nodes from histograms of well-behaved nodes.

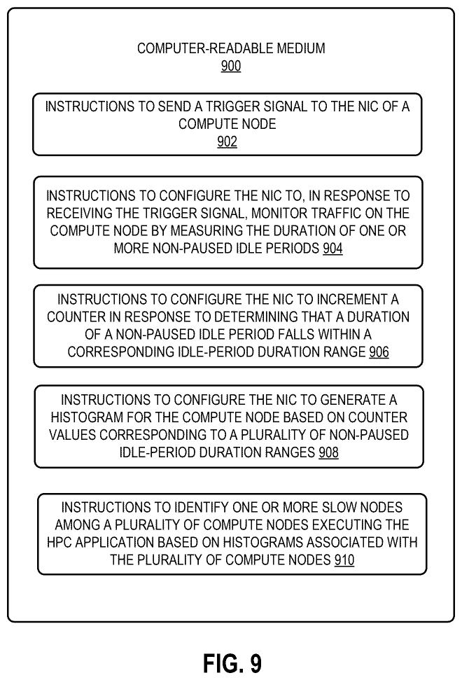

FIG. 9 illustrates a computer-readable medium that facilitates the identification of slow nodes, according to one aspect of the instant disclosure. In FIG. 9, computer-readable medium (CRM) 900 may be a non-transitory computer-readable medium or device storing instructions that when executed by a computer or processor cause the computer or processor to perform a method.

CRM 900 may include any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 900 may store instructions 902 to send a trigger signal to the NIC of a compute node, as described above in relation to operation 602 shown in FIG. 6; instructions 904 to configure the NIC to, in response to receiving the trigger signal, monitor traffic to or from the compute node by measuring the duration of one or more non-paused idle periods, as described above in relation to operation 604 shown in FIG. 6; instructions 906 to configure the NIC to increment a counter in response to determining that a duration of a non-paused idle period falls within a corresponding idle-period duration range, as described above in relation to operation 606 shown in FIG. 6; instructions 908 to configure the NIC to generate a histogram for the compute node based on counter values corresponding to a plurality of idle-period ranges, as described above in relation to operation 608 shown in FIG. 6; and instructions 910 to identify one or more slow nodes among a plurality of compute nodes executing the HPC application based on histograms associated with the plurality of compute nodes, as described above in relation to operation 610 shown in FIG. 6.

In general, the disclosure solves the technical problem of identifying slow nodes among a plurality of compute nodes executing one or more distributed applications (e.g., HPC or machine-learning applications). The NIC of each compute node may include hardware logic (e.g., counters, comparators, etc.) to measure durations of non-paused idle periods within a predetermined sample period and count the number of non-paused idle periods within each particular duration range to generate a histogram based on the counts. The NIC may be configured via a control and status register (CSR), which may include fields for configuring the sample period and widths of the bins in the histogram. The CSR may also include a “start” field that triggers the NIC to collect statistics about the non-paused idle periods. Statistics about the non-paused idle periods can be collected for ingress traffic, egress traffic, one or more traffic classes, etc. Histograms collected from the plurality of compute nodes may be analyzed (e.g., using a machine-learning technique) to identify the slow nodes. The same trigger mechanism may also be used to automatically gather many samples during the time an application or service is running. Although HPC applications are used as an example throughout this disclosure, the scope of the disclosure is not limited to HPC applications. Any application relying on distributed computing may use the provided solution to identify the slow nodes among a plurality of nodes executing the application.

One aspect of the instant disclosure provides a method and system for identifying slow nodes among a plurality of nodes executing a distributed application.

During operation, in response to receiving a trigger signal at a node, the system may monitor traffic to or from the node by measuring durations of one or more non-paused idle periods. In response to determining that a duration of a non-paused idle period falls within a predetermined idle-period duration range, the system may increment a corresponding counter. The system may generate a histogram for the node based on counter values corresponding to a plurality of idle-period duration ranges and identify one or more slow nodes based on histograms associated with the plurality of nodes.

In a variation on this aspect, receiving the trigger signal may include receiving, at a network interface controller (NIC) of the node, a configuration signal to update configuration of the NIC.

In a further variation, updating the configuration of the NIC may include updating a control and status register (CSR).

In a further variation, the CSR may include a field specifying an ingress or egress direction for monitoring the traffic.

In a further variation, the CSR may include one or more of: a field specifying one or more to-be-monitored traffic classes; a field specifying one or more to-be-monitored application or service; or a field specifying one or more phase in the execution of a particular application.

In a further variation, the CSR may include a field specifying a sample window during which the traffic is monitored, and the histogram may be generated based on traffic to or from the node within the sample window.

In a further variation, the system may further generate a trace comprising a plurality of histograms to indicate behaviors of the node over a duration comprising a plurality of sample windows.

In a further variation, the CSR may include a field specifying a width of a respective bin in the histogram corresponding to an idle-period duration range.

In a variation on this aspect, identifying the one or more slow nodes may include applying a machine-learning technique to the histograms.

In a variation on this aspect, the histogram may include a base bin with a predetermined first width, a set of normal bins each with a predetermined second width, and a remainder bin with a predetermined third width.

One aspect of the instant disclosure provides a network interface controller (NIC) of a node. The NIC may include a traffic-monitoring circuit to monitor traffic through the NIC by measuring durations of one or more non-paused idle periods in response to receiving a trigger signal; a plurality of counters corresponding to a plurality of idle-period duration ranges, a respective counter to be incremented in response to the traffic-monitoring circuit determining that a duration of a non-paused idle period falls within a corresponding idle-period duration range; and a histogram-generation circuit to generate a histogram for the node based on counter values corresponding to a plurality of idle-period duration ranges, the histogram to facilitate identification of one or more slow nodes within a plurality of nodes executing a distributed application.

One aspect of the instant disclosure provides a non-transitory machine-readable storage medium storing instructions executable by a processing resource to: configure a network interface controller (NIC) of a compute node to, in response to receiving a trigger signal, monitor traffic to or from the compute node by measuring durations of one or more non-paused idle periods; configure the NIC to increment a counter in response to determining that a duration of a non-paused idle period falls within a corresponding idle-period duration range; configure the NIC to generate a histogram for the compute node based on counter values corresponding to a plurality of idle-period duration ranges; and identify one or more slow nodes among a plurality of compute nodes executing a distributed application based on histograms associated with the plurality of compute nodes.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method for identifying slow nodes among a plurality of nodes executing a distributed application, the method comprising:
in response to receiving a trigger signal at a node, monitoring traffic to or from the node by measuring durations of one or more non-paused idle periods;
in response to determining that a duration of a non-paused idle period falls within a predetermined idle-period duration range, incrementing a corresponding counter;
generating a histogram for the node based on counter values corresponding to a plurality of idle-period duration ranges; and
identifying one or more slow nodes based on histograms associated with the plurality of nodes.

2. The method of claim 1, wherein receiving the trigger signal comprises receiving, at a network interface controller (NIC) of the node, a configuration signal to update configuration of the NIC.

3. The method of claim 2, wherein updating the configuration of the NIC comprises updating a control and status register (CSR).

4. The method of claim 3, wherein the CSR comprises a field specifying an ingress or egress direction for monitoring the traffic.

5. The method of claim 3, wherein the CSR comprises one or more of:
a field specifying one or more to-be-monitored traffic classes;
a field specifying one or more to-be-monitored application or service; or
a field specifying one or more phase in the execution of a particular application or service.

6. The method of claim 3, wherein the CSR comprises a field specifying a sample window during which the traffic is monitored, and wherein the histogram is generated based on traffic to or from the node within the sample window.

7. The method of claim 6, further comprising generating a trace comprising a plurality of histograms to indicate behaviors of the node over a duration comprising a plurality of sample windows.

8. The method of claim 3, wherein the CSR comprises a field specifying a width of a respective bin in the histogram corresponding to an idle-period duration range.

9. The method of claim 1, wherein identifying the one or more slow nodes comprises applying a machine-learning technique to the histograms.

10. The node of claim 1, wherein the histogram comprises a base bin with a predetermined first width, a set of normal bins each with a predetermined second width, and a remainder bin with a predetermined third width.

11. A network interface controller (NIC) of a node, comprising:
a traffic-monitoring circuit to monitor traffic through the NIC by measuring durations of one or more non-paused idle periods in response to receiving a trigger signal;
a plurality of counters corresponding to a plurality of idle-period duration ranges, a respective counter to be incremented in response to the traffic-monitoring circuit determining that a duration of a non-paused idle period falls within a corresponding idle-period duration range; and
a histogram-generation circuit to generate a histogram for the node based on counter values corresponding to a plurality of idle-period duration ranges, the histogram to facilitate identification of one or more slow nodes within a plurality of nodes executing a distributed application.

12. The NIC of claim 11, wherein receiving the trigger signal comprises receiving a configuration signal to update configuration of the NIC.

13. The NIC of claim 12, further comprising a control and status register (CSR), wherein the configuration signal is to update the CSR.

14. The NIC of claim 13, wherein the CSR comprises one or more of:
a field specifying an ingress or egress direction for monitoring the traffic;
a field specifying one or more to-be-monitored traffic classes;
a field specifying one or more to-be-monitored application or service;
a field specifying one or more phase in the execution of a particular application or service;
a field specifying a sample window during which the traffic is monitored; or
a field specifying a width of a respective bin in the histogram corresponding to an idle-period duration range.

15. The NIC of claim 14, wherein the histogram-generation circuit is to generate a trace comprising a plurality of histograms to indicate behaviors of the node over a duration comprising a plurality of sample windows.

16. The NIC of claim 11, wherein the one or more slow nodes are identified based on a machine-learning technique and histograms corresponding to the plurality of nodes.

17. The NIC of claim 11, wherein the histogram comprises a base bin with a predetermined first width, a set of normal bins each with a predetermined second width, and a remainder bin with a predetermined third width.

18. A non-transitory machine-readable storage medium storing instructions executable by a processing resource to:
configure a network interface controller (NIC) of a compute node to, in response to receiving a trigger signal, monitor traffic to or from the compute node by measuring durations of one or more non-paused idle periods;
configure the NIC to increment a counter in response to determining that a duration of a non-paused idle period falls within a corresponding idle-period duration range;
configure the NIC to generate a histogram for the compute node based on counter values corresponding to a plurality of idle-period duration ranges; and
identify one or more slow nodes among a plurality of compute nodes executing a distributed application based on histograms associated with the plurality of compute nodes.

19. The non-transitory machine-readable storage medium of claim 18, the instructions further to update a control and status register (CSR).

20. The non-transitory machine-readable storage medium of claim 19, wherein the CSR comprises one or more of:
a field specifying an ingress or egress direction for monitoring the traffic;
a field specifying one or more to-be-monitored traffic classes;
a field specifying one or more to-be-monitored application or service;
a field specifying one or more phase in the execution of a particular application or service;
a field specifying a sample window during which the traffic is monitored; or
a field specifying a width of a respective bin in the histogram corresponding to an idle-period duration range.
